(19) United States
(12) Patent Application Publication
(10) Pub. No.: US 2008/0124071 A1
(43) Pub. Date: May 29, 2008

(54) CAMERA AND PORTABLE ELECTRONIC DEVICE USING THE SAME

(76) Inventor: Sung-Hun KIM, Seoul (KR)

Correspondence Address: CHA & REITER, LLC, 210 ROUTE 4 EAST STE 103, PARAMUS, NJ, 07652, US

(21) Appl. No.: 11/944,661

(22) Filed: Nov. 26, 2007

(30) Foreign Application Priority Data
Nov. 27, 2006 (KR) 2006-117903

(51) Int. Cl. G03B 17/00

(52) U.S. Cl. 396/448

(57) ABSTRACT

A camera and/or a portable electronic device using the same include a hood that prevents/reduces flared images yet does not increase the footprint of the camera or portable device. A barrel has a groove that is formed in the circumferential direction at one end of the barrel, the one end facing a subject, a lens system is arranged within an inner circumferential face of the barrel and a hood inserted into the groove that can protrude or retract from the barrel. At least one elastic member is preferably mounted inside the groove to be in contact with one end of the hood.

### CLAIM OF PRIORITY

This application claims the benefit under 35 U.S.C. § 119(a) from a Korean Patent Application filed in the Korean Intellectual Property Office on Nov. 27, 2006 and assigned Serial No. 2006-117903, the entire disclosure of which is hereby incorporated by reference in its entirety.

### BACKGROUND OF THE INVENTION

1. Field of the Invention

The present invention generally relates to a camera, and in particular, to a camera having a hood.

2. Description of the Related Art

Cameras are optical devices for storing light incident through a lens system having a plurality of lenses in communication with an image sensor, or a film in an image of a target object (or subject) is stored. With the recent development of semiconductor technology, a digital camera having an image sensor in which a plurality of optical detectors are integrated as pixels has become commonly used and is increasing in popularity.

Digital cameras have comparatively low maintenance costs and take up much less space when compared to an analog camera using conventional film. In particular, recent digital cameras have evolved into complex electronic devices by being mounted in portable wireless communication terminals or various portable digital devices, such as camera-phones, etc.

One of the problems with digital cameras has to do with flare. Flare, which is generally defined as unwanted reflection in an optical system and/or the fogging of an image caused by an unwanted reflection, can seriously impair the quality of digitally recorded images. More specifically, flare causes optical problems due to the diffuse reflection during the incidence of light into the lens system, and an image that is not intended by a user may be captured due to flare.

To minimize flare, camera manufacturers typically install a hood in a front face of a lens system of a camera into which light is incident, i.e., a face that faces a subject, and thus prevents unnecessary light from being incident into the camera and causing flared images. Hoods typically extend from the end of many conventional cameras. However, since a camera having a conventional fixed hood has a large volume, whereas digital cameras are often small enough to fit in one's pocket or even on a keychain, conventional hoods are is not suitable for use in a portable digital device or a portable wireless terminal, such as a camera-phone. On the other hand, a removable hood for a portable digital device or a portable wireless terminal still has to be carried at all times for use and thus may be lost when carried around separately from the portable digital device, and defeats one of the benefits of using a digital camera, that being the small footprint of the device.

### SUMMARY OF THE INVENTION

The present invention has been made to address at least some of the above-mentioned problems and/or disadvantages and to provide at least the advantages described below. Accordingly, an aspect of the present invention is to provide a camera having a hood so that the camera can be conveniently carried without removal of the hood.

Another aspect of the present invention is to provide a hood for a camera that is mounted in or on a portable digital device or a portable wireless communication terminal.

According to another aspect of the present invention, there is provided a camera including a barrel having a groove that is formed in the circumferential direction at one end of the barrel, the one end facing a subject, and a lens system inserted into the inner circumferential face of the barrel. A hood is inserted into the groove, and elastic members are mounted inside the groove in such a way to contact one end of the hood.

According to yet another aspect of the present invention, there is provided a portable electronic device including an upper housing and a lower housing that can be opened/closed, and a camera module having a hood mounted in one of the upper housing and the lower housing. The hood automatically protrudes or inserted according to opening/closing of the upper housing or the lower housing.

### BRIEF DESCRIPTION OF THE DRAWINGS

The above and other features and advantages of exemplary embodiments of the present invention will become more apparent from the following detailed description taken in conjunction with the accompanying drawings, in which:

FIG. 1 is an exploded cross-sectional view of a camera according to a first exemplary embodiment of the present invention;

FIG. 2A is a perspective view of a portable electronic device having a camera module according to a second exemplary embodiment of the present invention;

FIG. 2B illustrates a hood of a camera module illustrated in FIG. 2A;

FIG. 2C illustrates a lower housing of a portable electronic device illustrated in FIG. 2A; and

FIGS. 3A through 3C are views for showing insertion or protrusion of a hood in a portable electronic device such as illustrated in FIGS. 2A through 2C.

Throughout the drawings, the same drawing reference numerals will be understood to refer to the same or similar elements, features and structures.

### DETAILED DESCRIPTION OF THE INVENTION

The following detailed description includes exemplary embodiments of some of the ways the present invention can be constructed, and the drawings and descriptions are provided for purposes of illustration and not for limitation of the invention. A person or ordinary skill in the art appreciates that while the description is provided to assist in a comprehensive understanding of the invention, the artisan also recognizes that various changes and modifications of the embodiments and/or elements described herein can be made without departing from the spirit of the invention and the scope of the appended claims. Also, descriptions of well-known functions and structures may be omitted so as not to obscure the present invention with unnecessary detail of such well-known functions and structures.

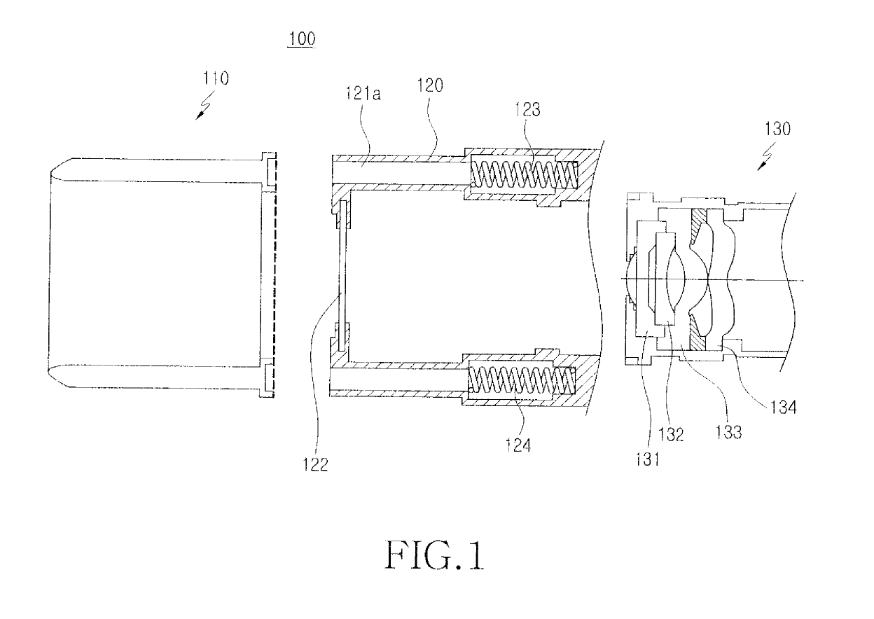

FIG. 1 is an exploded cross-sectional view of a camera 100 according to a first exemplary embodiment of the present invention. Referring to FIG. 1, the camera 100 includes a barrel 120 having a groove 121a formed in the circumferential direction at one end that faces a subject to be photographed, a lens system 130 arranged within the inner circumferential face of the barrel 120, a hood 110 inserted into the groove 121a, and elastic members 123 and 124 mounted inside the groove 121a and in contact with one end of the hood 110.

Still referring to FIG. 1, the lens system 130 is arranged in the inner circumferential face of the barrel 120 such that its optical axis is parallel with the longitudinal axis of the barrel 120. The lens system 130 may include, for example, at least one or more of lenses 131, 132, 133, and 134. A general lens system may include a lens for suppressing aberration and lenses for imaging an image of a subject on an image sensor or a film. However, it should be understood that the number of lenses can be more or less than shown and described, or different types of a lens(es).

The groove 121a, in which an end of the hood 110 is arranged, extends along the optical axis of the barrel 120 between the inner circumferential face of the barrel 120 and the outer circumferential face of the barrel 120. One end of the groove 121a, which faces a subject to be photographed, is opened and thus the hood 110 is inserted and mounted into the groove 121a. The elastic members 123 and 124 provide biasing and may comprise a spring and/or a resilient material that provides an elastic force for extension or retraction of the hood 110 from within the barrel 120 of camera 100.

Still referring to FIG. 1, the camera 100 has no increase in its volume or an increased footprint with the integrated hood 110, which may protrude from barrel 120 or be inserted (retract) within the barrel 120 according to a particular function being performed with the camera. Therefore, the camera 100, with the hood 110, can be easily applied to recent multi-function and multi-integration portable digital or electronic devices that tend towards convergence.

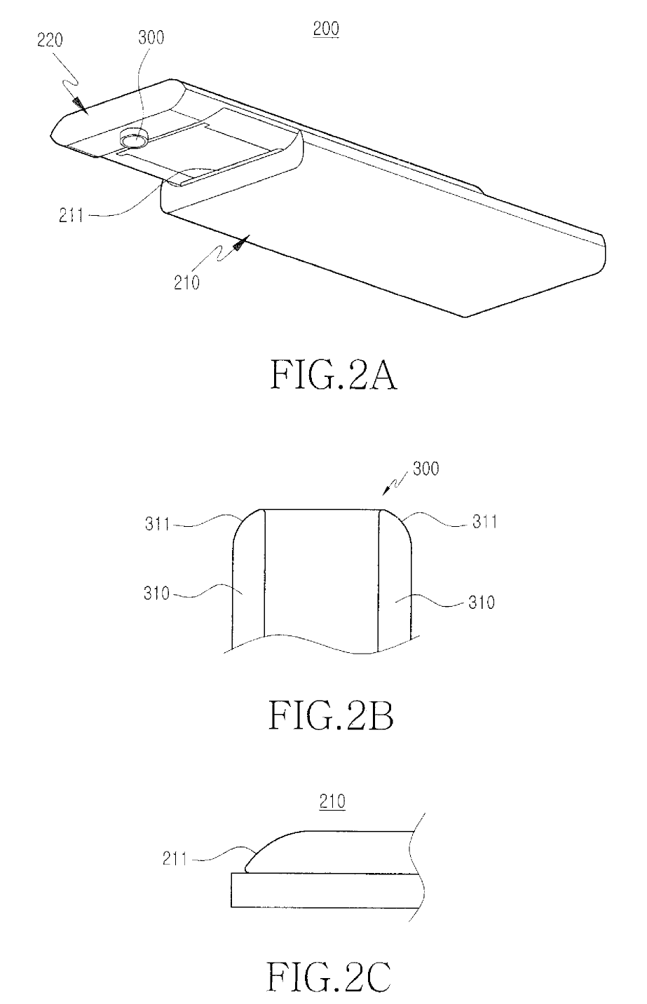

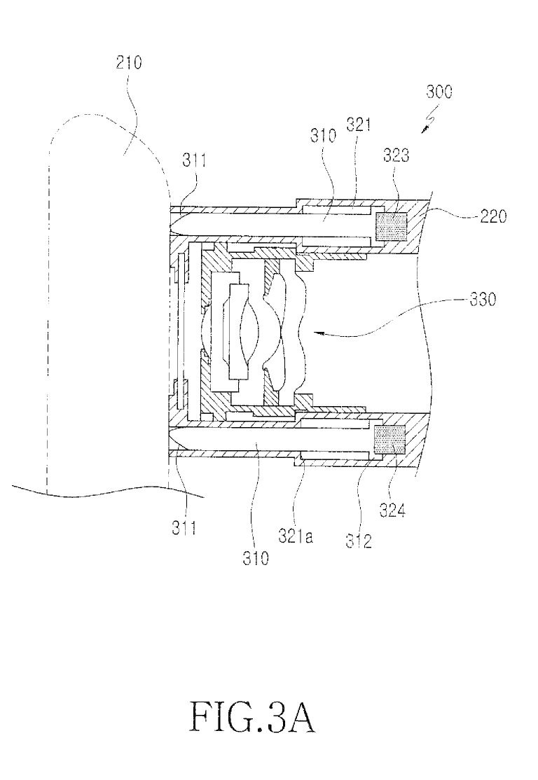

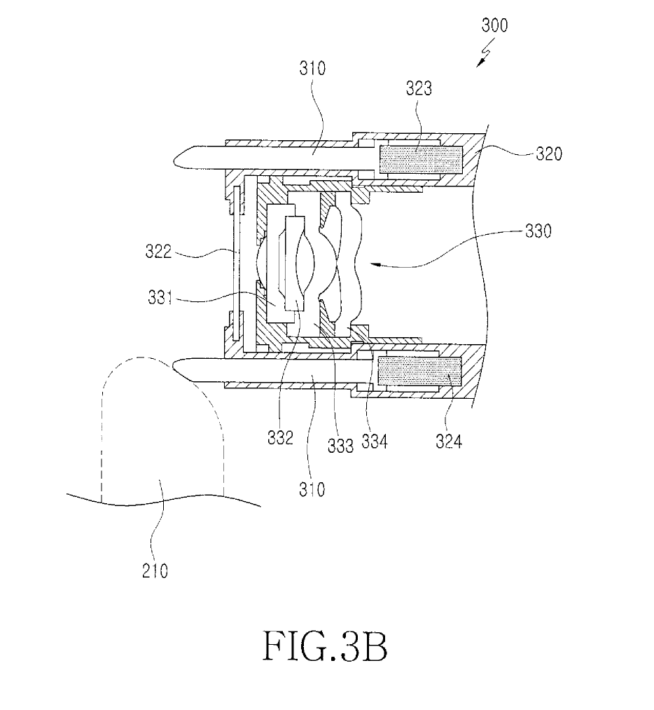

FIG. 2A is a perspective view of a portable electronic device 200 having a camera module 300 according to a second exemplary embodiment of the present invention, FIG. 2B illustrates a hood 310 of the camera module 300, and FIG. 2C illustrates a lower housing of the portable electronic device 200. The portable electronic device 200 includes an upper housing 220 and a lower housing 210 that can be opened/closed and the camera module 300 having the hood 310 mounted in one of the upper housing 220 and the lower housing 210. The hood 310 can protrude or retract according to opening/closing of the upper housing 220 or the lower housing 210.

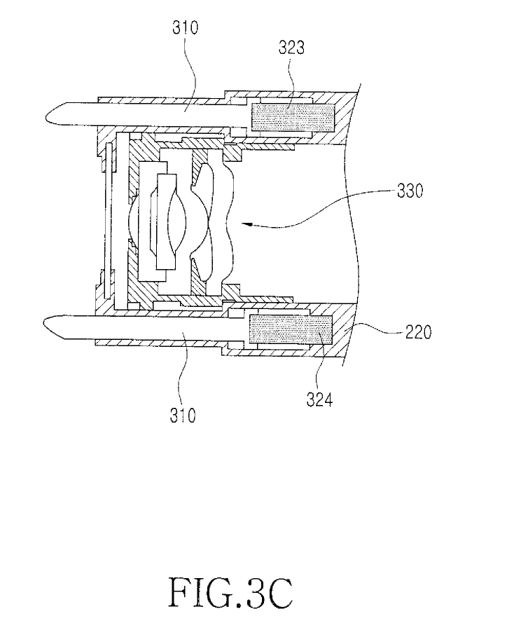

FIGS. 3A through 3C are views for showing extension or retraction of the hood 310 in a portable electronic device 200. The camera module 300 includes a lens system 330, a groove 321 formed along the circumference of the lens system 330 in one of the upper housing 220 and the lower housing 210 in which the lens system 330 is mounted. The hood 310 is mounted in the groove 321. The camera module 300 also includes elastic members 323 and 324 between the bottom of the inside of the groove 321 and the hood 310.

Referring to FIGS. 3A and 3B, the hood 310 has in part an inclined surface 311 having a predetermined curvature at its outer side, and the lower housing 210 also has an inclined surface 211 having a predetermined curvature at its side facing the inclined surface 311 of the hood 310. In other words, as the hood 310 and the lower housing 210 have their respective inclined surfaces 311, 211 facing each other (as shown in FIG. 3B, the hood 310 can extend (protrude) from or retract into the groove 321 for sliding-type opening/closing.

FIG. 3A is a cross-sectional view of a portion of the portable electronic device 200 in which the lower housing 210 and the upper housing 220 are closed. In the example shown FIG. 3A, the hood 310 is retracted in its entirety into the groove 321. It is also possible that the hood substantially retracts into the groove, but not entirely therein.

FIG. 3B is a cross-sectional view a portion of the portable electronic device 200 in which the lower housing 210 is partially opened. As shown in FIG. 3B, the inclined surface 311 of the hood 310 faces the inclined surface 211 of the lower housing 210. The hood 310 extends (protrudes) from the groove 321 after the lower housing 210 is partially opened. FIG. 3C is a cross-sectional view a portion of the portable electronic device 200 in which the lower housing 210 is completely opened. In FIG. 3C, the hood 310 maximally protrudes (extends) from the groove 321.

According to the present invention, for a slide or folder opening/closing-type electronic terminal, or portable wireless communication terminal having a camera, the camera includes a hood that automatically extends or retracts through the use of elastic members to apply a biasing force to the hood. Accordingly, the present invention provides a convenient way to keep the hood (which is used to prevent flared images when certain light conditions are not favorable) attached to the camera so the hood does not require a separate carrying space and would be subject to loss or damage, yet, at the same time, permit the hood to retract into the groove so that the overall size/footprint of the camera when closed is not increased. With devices including but not limited to keychain attached cameras and camera features in mobile terminals, the retention of the same footprint of the camera or device provides a considerable advantage over conventional hood systems. Mobile terminals, including but not limited to mobile telephones having a camera therein, and/or PDAs, and/or cameras that are typically carried or worn by a user, are just a few of the devices that will greatly benefit from the present invention.

While the invention has been shown and described with reference to exemplary embodiments thereof, it will be understood by those skilled in the art that various changes in form and details may be made therein without departing from the spirit and scope of the invention. For example, the inclined surface of the hood and the housing shown in FIGS. 3A-3C could have different degrees of inclination, or other geometric shapes. It is also possible that the hood could have a telescopic design that does not include biasing, although the examples shown and described prefer a construction including biasing members. In addition, the elastic members can be any type of spring, including but not limited to coil or leaf springs, or a material having sufficient elasticity to provide a force sufficient to bias the position of the hood.

What is claimed is:

1. A camera comprising:
a barrel having a first end and a second end, and a groove formed in a circumferential direction at the first end of the barrel, the first end facing toward a subject, and the barrel includes an inner circumferential face and an outer circumferential face;
a lens system arranged within the inner circumferential face of the barrel;
a hood inserted into the groove; and
one or more elastic members mounted inside the groove toward the second end of the barrel and in contact with one end of the hood.

2. The camera according to claim 1, wherein the inner circumferential face has an opening therein, and a lens system arranged within the inner circumferential face such that an optical axis of the lens system is substantially parallel with a longitudinal axis of the barrel.

3. The camera according to claim 2, wherein the groove extends along the optical axis of the barrel between the inner circumferential face of the barrel and the outer circumferential face of the barrel.

4. The camera according to claim 1, wherein the lens system comprises one lens.

5. The camera according to claim 1, wherein the lens system comprises a plurality of lenses.

6. The camera according to claim 3, wherein the lens system comprises a plurality of lenses.

7. The camera according to claim 1, wherein the elastic members comprise biasing members.

8. The camera according to claim 7, wherein the biasing members comprise springs.

9. A mobile terminal comprising a camera according to claim 3.

10. A personal digital assistant (PDA) comprising a camera according to claim 3.

11. A portable electronic device comprising:
an upper housing and a lower housing that can be opened/closed; and
a camera module having a hood mounted in one of the upper housing and the lower housing,
wherein the hood automatically protrudes or retracts according to whether the upper housing or lower housing is opened/closed.

12. The portable electronic device of claim 11, wherein the camera module comprises:
a lens system mounted in the upper housing or the lower housing;
a groove formed along the circumference of the lens system in the upper housing or the lower housing having a lens system mounted therein and in which the hood is removably mounted; and
elastic members mounted inside the groove to provide an elastic force for extending the hood outward from the portable electronic device.

13. The portable electronic device of claim 11, wherein a side of the upper housing or the lower housing, which is in contact with an outer side of the hood, has a predetermined curvature.

14. The portable electronic device of claim 10, wherein a portion of an outer side of the hood, which is in contact with the upper housing or the lower housing, has a predetermined curvature.
